(19) United States
(12) Patent Application Publication
(10) Pub. No.: US 2004/0249732 A1
(43) Pub. Date: Dec. 9, 2004

(54) Systems and methods for trading emission reduction benefits

(76) Inventor: Stephen M. Drummond, London (GB)

Correspondence Address: FISH & NEAVE LLP, 1251 AVENUE OF THE AMERICAS, 50TH FLOOR, NEW YORK, NY, 10020-1105, US

(21) Appl. No.: 10/824,954

(22) Filed: Apr. 14, 2004

Related U.S. Application Data
(60) Provisional application No. 60/463,140, filed on Apr. 14, 2003.

(51) Int. Cl. G06F 17/60

(52) U.S. Cl. 705/30

(57) ABSTRACT

An electronic trading system and method for facilitating the creation of emission reducing projects and trading emission reductions benefits are provided. An emission reducing project is a project that reduces the amount of carbon dioxide equivalent emissions generated by a supplier or the supplier's operation. A volume of emission reduction benefits is generated from the emission reducing project. The volume of emission reduction benefits is based at least in part on the amount of carbon dioxide equivalents that is removed from or prevented from entering the environment. The emission reduction benefits may be stored in a warehouse. The warehouse may divide the volume of emission reduction benefits into smaller volumes to be sold to buyers and/or customers. The carbon management application may manage the sale of the emission reduction benefits to buyers and customers. In response to a buyer or a customer purchasing emission reduction benefits, the carbon management application issues an emissions retirement guarantee to the buyer or the customer.

### CROSS-REFERENCE TO RELATED APPLICATIONS

This application claims the benefit of U.S. provisional application No. 60/463,140, filed Apr. 14, 2003, which is hereby incorporated by reference herein in its entirety.

### BACKGROUND OF THE INVENTION

The present invention relates to systems and methods for trading emission reduction benefits. More particularly, this invention relates to systems and methods for allowing a warehouse to provide emission reduction benefits to buyers and customers.

Carbon dioxide equivalent (CO₂e) is the universal unit of measurement used to indicate the global warming potential of greenhouse gases. Some examples of greenhouse gases are carbon dioxide (CO₂), water vapor (H₂O), methane (CH₄), chlorofluorocarbons (CFCs), nitrous oxide (N₂O), hydrofluorocarbons (HFCs), perfluorocarbons (PFCs), and sulfur hexafluoride (SF₆). Possible methods of reducing CO₂e emissions include reducing actual emissions, avoiding potential emissions, or removing and storing atmospheric carbon in a sink. Emission reductions may qualify for accreditation under current or future international regulatory regimes, domestic regulatory regimes, or both.

In an evolving CO₂e emission reductions trading market and with the ever-growing desire to become environmentally friendly, buyers (e.g., countries, corporations, non-profit organizations, or individuals) may desire to offset the climate-damaging greenhouse gas emissions that are associated with the production and consumption of their products, services, and/or processes (i.e., making their products, services, and/or processes emissions neutral). However, some buyers may not be aware of these approaches to make their products, services, and/or processes emissions neutral.

Furthermore, while a buyer can purchase emission reduction benefits, these emission reduction benefits are purchased and sold only in large quantities. For example, a supplier may offer emission reduction benefits that are available in quantities of fifty thousand tons. Emission reduction benefits are sold in large quantities because these benefits must be verified and authenticated by a regulatory body, such as an international regulatory body, a domestic regulatory body, or both. Therefore, it would be desirable to facilitate the trading and managing of any quantity or volume of emission reduction benefits and management thereof.

It would also be desirable to provide trading systems and methods for providing buyers with an opportunity to make a product, process, or service to become emissions neutral.

It would further be desirable to provide trading systems and methods for creating emission reduction opportunities.

### SUMMARY OF THE INVENTION

In accordance with the present invention, electronic systems and methods for facilitating the creation of emission reducing projects and trading emission reduction benefits are provided.

To better appreciate the following details, the nomenclature is defined below. The illustrative examples herein, but not limited to them, all focus on emission reductions, as well as the creating and trading of emission reduction benefits.

The following terms are used with the associated definitions:

| | |
|---|---|
| Emission reducing | A project that generates emission |
| project | reduction benefits (ERBs). |
| Basket | A mechanism for grouping together |
| | emission reducing projects into |
| | one unit. Baskets can be thought |
| | of as a fund made up of emission |
| | reducing projects. A basket |
| | allows a consumer to make an |
| | emissions neutral purchase using |
| | several projects rather than only |
| | a single project. |
| Emission reduction | The environmental value created |
| benefit (ERB) | by the emission reduction in the |
| | warehouse. |
| Emission retirement | The promise of retirement of an |
| guarantee (ERG) | emission reduction benefit. |
| Instrument | An emission reduction benefit |
| | defined by vintage year -- e.g., |
| | an emission reduction benefit |
| | from Project Tango, vintage year |
| | 2004. |
| Product | A term that refers to both |
| | emission reducing projects and |
| | baskets. |
| Warehouse | An entity that takes ownership of |
| | the emission reduction benefits. |
| Supplier | An entity that sells emission |
| | reduction benefits to the |
| | warehouse. |
| Marketing Agent | An entity who markets the concept |
| | of “emissions neutrality” to |
| | buyers -- e.g., sales and |
| | marketing organizations. |
| Buyer | An entity -- e.g., a corporation, |
| | a non-profit organization, an |
| | individual - who wants to sell an |
| | emissions neutral product or |
| | advertise that they have |
| | emissions neutral processes. A |
| | buyer pays for the retirement of |
| | an emission reduction benefit. |
| Retailer | An entity who sells products or |
| | services that have greenhouse gas |
| | emissions associated with their |
| | production or use. The products |
| | or services may be sold, for |
| | example, over the Internet. The |
| | retailer offers their customers |
| | the option to make products or |
| | services emissions neutral by |
| | providing their customers with |
| | the option to pay for the |
| | retirement of an emission |
| | reduction benefit. |
| Customer | An entity who chooses to purchase |
| | an emissions neutral product or |
| | service. |
| Broker | An entity who identifies projects |
| | for the warehouse. This entity |
| | may negotiate with a supplier and |
| | may arrange the transaction. |
| | This entity may expect to be paid |
| | a commission by the supplier |
| | and/or the warehouse. |
| Carbon Visa | The name for the buyer account. |
| | This describes the institution of |
| | an account that allows a buyer to |
| | use all warehouse properties. |

In some embodiments, the carbon management application of the present invention may allow a warehouse to engage in a transaction with a supplier and a buyer. The carbon management application may allow a warehouse to assess a supplier in connection with the carbon dioxide equivalent emissions of the supplier. The assessment may include a suggestion for creating an emission reducing project to reduce the emissions of the supplier's operation. In some embodiments, the assessment may be generated by a broker. The carbon management application may receive a request from a supplier to create an emission reducing project or an indication that an emission reducing project has been performed. In some embodiments, the supplier may assign the emission reduction benefits generated from the emission reducing project to the warehouse in response to the purchasing or funding of the project by the warehouse. In response to funding the supplier's emission reducing project or purchasing emission reduction benefits, the warehouse may input the number of emission reduction benefits into the carbon management application and store the emission reduction benefits received from the supplier in the warehouse. The number of benefits may be determined based amount of CO₂e that is removed from or prevented from entering the environment as a result of the emission reducing project.

In response to storing the emission reduction benefits, the warehouse may allow an independent auditor, regulatory agency, or any other suitable entity to verify that the proper number of emission reduction benefits have been inputted into the carbon management application. The auditor may also ensure that the same emission reduction benefits are not sold to multiple buyers and/or customers and that the emission reduction benefits are properly retired. In response to verifying the emission reduction benefits, the warehouse may divide the emission reduction benefits received from the supplier into smaller volumes of emission reductions benefits.

The carbon management application may communicate a notification of the available emission reducing projects and emission reduction benefits to a buyer or a customer. In some embodiments, the carbon management application may communicate the notification to a marketing agent. The marketing agent may then manage or assist the buyer or the customer with the sale of the emission reduction benefits.

The carbon management application may then provide the buyer or the customer with the ability to purchase some or all of the available emission reduction benefits. In response to receiving a request to purchase available emission reduction benefits, the carbon management application may prompt the buyer to input transaction information. Transaction information may include, for example, the volume of emission reducing benefits, the agreed-upon price of the benefits, the name of the emission reducing project and the associated benefits, the date of the transaction, total price of the transaction, or any other suitable transaction information. Transaction information may also include information communicated to the marketing agent. In response to processing the request, the carbon management application may notify the warehouse of the transaction. Upon notifying the warehouse of the completion of the transaction, the carbon management application may provide the buyer or the customer with an emission retirement guarantee which indicates the purchase of a specific volume of emission reduction benefits and guarantees its retirement.

In response to the buyer purchasing the emission retirement guarantee from the warehouse, the buyer may use the emission retirement guarantee to offset CO₂e emissions generated by the buyer's products, services, and/or processes. In some embodiments, the buyer may purchase a specific volume of emission retirement guarantees such that buyer may obtain products, services, and/or processes that are emission neutral.

The warehouse may determine the volume of emission retirement guarantees that the buyer has to purchase in order to become emissions neutral. For example, the carbon management application may assess the buyer's products, services, and/or processes and determine the amount of CO₂e emissions generated. When the buyer purchases a specific volume of emissions retirement guarantees such that the buyer's products, services, and/or processes are emission neutral, the carbon management application may generate an electronic or printed notification to the buyer indicating that the buyer has become emissions neutral.

In response to becoming emission neutral, the buyer may advertise to a customer that the buyer and the buyer's associated products, services, and/or processes are emission neutral. Advertising emission neutrality may be sufficient enough to attract the customer into purchasing a product or service from the buyer.

In response to a customer purchasing an emission reduction benefit, the warehouse or the buyer preferably provides the customer with an emission retirement guarantee. The emission retirement guarantee may state the number of emission reduction benefits that are retired from a particular emission reducing project and that the associated emission reduction benefits are “put beyond use” and may not be sold, used for compliance, or used for any other purpose.

In some embodiments, the warehouse may provide the customer with a quote based on the volume of emission reduction benefits needed to make the customer's purchase emissions neutral. For example, when the customer is purchasing an airline ticket, the customer may be provided with an option to charge twenty dollars in addition to the original airline ticket in order to make the purchase emission neutral.

### BRIEF DESCRIPTION OF THE DRAWINGS

Further features of the present invention, its nature, and various advantages will be more apparent from the following detailed description of the preferred embodiments, taken in conjunction with the accompanying drawings, in which like reference characters refer to like parts throughout, and in which:

FIG. 1 is a block diagram of a system that may be used to implement the processes and functions of some embodiments of the present invention;

FIG. 2 is a block diagram of an illustrative, generalized arrangement for the consumer access device and the servers of FIG. 1 in accordance with some embodiments of the present invention;

FIG. 3 shows an example of a transaction flow in accordance with some embodiments of the present invention.

FIG. 4 shows another example of a transaction flow in accordance with some embodiments of the present invention.

FIG. 5 shows an illustrative site map 500 that may be provided to a buyer by the carbon management application in accordance with some embodiments of the present invention.

FIG. 6 shows an illustrative site map 600 that may be provided to a marketing agent by the carbon management application in accordance with some embodiments of the present invention.

FIG. 7 shows an illustrative site map 700 that may be provided to a warehouse by the carbon management application in accordance with some embodiments of the present invention.

FIG. 8 shows an illustrative site map 800 that may be provided to a customer by the carbon management application in accordance with some embodiments of the present invention.

FIG. 9 is a flow chart of an illustrative method involved in allowing a warehouse to engage in a transaction with a supplier and a buyer in accordance with some embodiments of the present invention.

FIG. 10 is a flow chart of an illustrative method involved in allowing a buyer to provide emission neutral products, services, and/or processes to a customer in accordance with some embodiments of the present invention.

### DETAILED DESCRIPTION OF THE INVENTION

This invention relates to systems and methods for trading and managing emission reduction benefits using a carbon management application.

Aspects of the invention apply to various types of electronic trading, but are described herein primarily in the context of electronic trading of carbon dioxide equivalent (CO₂e) emission reducing projects and the emission reduction benefits resulting from the emission reducing projects for specificity and clarity.

As used herein, the carbon dioxide equivalent (CO₂e) is the universal unit of measurement used to indicate the global warming potential of greenhouse gases. Emission reduction may refer to a reduction in actual emission, avoidance of potential emission, or the removal of atmospheric carbon and storage in a warehouse.

It should be noted that although the following embodiment of the invention relates to the trading of an emission reducing project or the creation of an emission neutral product that supports a single emission reducing project, this invention is not limited only to a single emission reduction project. Rather, the invention may also be applied to an emission neutral product that supports a basket of multiple emission reducing projects. For example, a warehouse may create baskets from multiple emission reducing projects. In another suitable example, a buyer may sell a product that supports the retirement of multiple emission reduction benefits.

In some embodiments, users (e.g., a buyer, a trader, a broker) may be provided with access to a carbon storage application. For example, a broker may assist a supplier in arranging the transaction (e.g., the sale of emission reduction benefits) between the supplier and a warehouse. The supplier is any suitable entity that creates emission reducing projects. An emission reducing project is a project that reduces the amount of CO₂e emissions generated by the supplier's operation. The emission reducing project generates a specific amount of emission reduction benefits. The number of emission reduction benefits may be based at least in part on the amount of CO₂e that is removed from or prevented from entering the environment as a result of the emission reducing project. Emission reduction benefits are preferably stored in a warehouse. A warehouse is any suitable entity that stores and retains ownership of the emission reduction benefits.

In order to reduce the burden on the warehouse in obtaining emission reduction benefits from suppliers, the warehouse may allow a broker to communicate with suppliers regarding the sale of emission reduction benefits. The broker may assist the supplier in identifying emission reducing projects. For example, the broker may assess the supplier's operation and determine potential emission reducing projects based on the assessment. In response to assessing the supplier's operation, the broker may input information relating to the supplier into the carbon management application. Such information may include, for example, the name of the supplier, the number of available emission reduction benefits, potential emission reducing projects, or any other suitable information relating to the supplier. The carbon storage application may assist the warehouse in managing and facilitating the trading of these emission reduction benefits.

In some embodiments, the carbon management application may also allow a marketing agent to access the carbon management application. The marketing agent may provide the warehouse with a proposed marketing approach to the warehouse. Such a marketing approach may include an approach for presenting the buyer with the ability to provide emissions neutral products, services, and/or processes. For example, the marketing agent may entice a buyer into creating emissions neutral products, services, and/or processes by preparing a customized presentation tailored to the buyer and the buyer's industry.

In order to reduce the burden on the warehouse in managing such a marketing scheme, the warehouse may direct the marketing agent to manage the presentation of the marketing scheme, related emission reduction benefits, and corresponding fees to potential buyers. The marketing agent may input information from the potential buyers into the carbon management application. Such information may include, for example, comments from the marketing agent relating to a potential buyer, contact information for the potential buyer, or any other suitable information. In response to the marketing agent inputting such information, the carbon management application may track the buyers and how the buyers interact with the warehouse.

In some embodiments, in response to a buyer engaging in a transaction with the warehouse, the carbon management application may direct the marketing agent to assist the buyer in setting up a membership account with the warehouse and to qualify the transaction. In some embodiments, fees may be owed to the broker and the marketing agent in connection with the transaction.

In addition to presenting opportunities for providing emissions neutral products, services, and/or processes, the carbon management application may provide buyers and customers with the ability to view lists of available emission reduction benefits and search for available emission reduction benefits using, for example, one or more web pages. The lists (e.g., generic or personalized) may include available emission reduction benefits, which may assist buyers and customers in finding available emission reduction benefits. For example, the warehouse may host one or more listing display Web pages that list emission reduction benefits available to buyers and customers and provide access to further information about the details of an emission reduction benefit.

Notwithstanding that the present invention is described herein as involving a supplier, a warehouse, a buyer, and a customer, it should be apparent that other participant arrangements are possible. For example, in one suitable embodiment, a broker may be allowed to interact with the warehouse. In some embodiments, the broker may be part of the warehouse. As another example, the marketing agent may be allowed to interact with the warehouse. Any other suitable arrangement may be used.

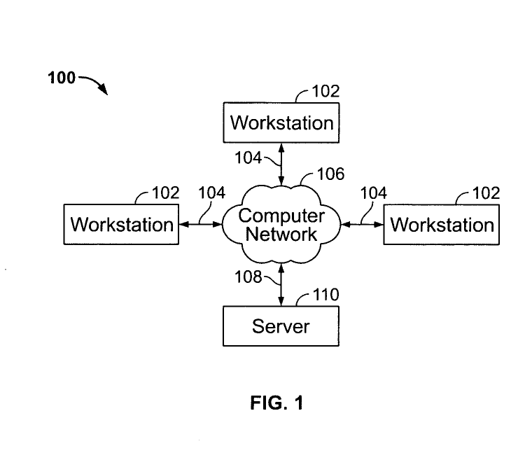

Further details of the invention are described below with respect to FIGS. 1-10.

FIG. 1 is a schematic diagram of an illustrative electronic trading system 100 suitable for implementation of a carbon management application in accordance with the present invention. Referring to FIG. 1, an exemplary system 100 for implementing the present invention is shown. As illustrated, system 100 may include one or more trading workstations 102. Workstations 102 may be local to each other or remote from each other, and are connected by one or more communications links 104 to a computer network 106 that is linked via a communications link 108 to a server 110.

In system 100, server 110 may be any suitable server for providing access to the carbon management application, such as a processor, a computer, a data processing device, or a combination of such devices. In one example, server 110 may be a server powered by CO2e.com, LLC of One America Square, London EC3N 2LS United Kingdom. Computer network 106 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 104 and 108 may be any communications links suitable for communicating data between workstations 102 and server 110, such as network links, dial-up links, wireless links, hard-wired links, etc. Workstations 102 enable buyers and customers to engage in the trading process. Workstations 102 may be personal computers, laptop computers, mainframe computers, dumb terminals, data displays, Internet browsers, personal digital assistants (PDAs), two-way pagers, wireless terminals, portable telephones, etc., or any combination of the same.

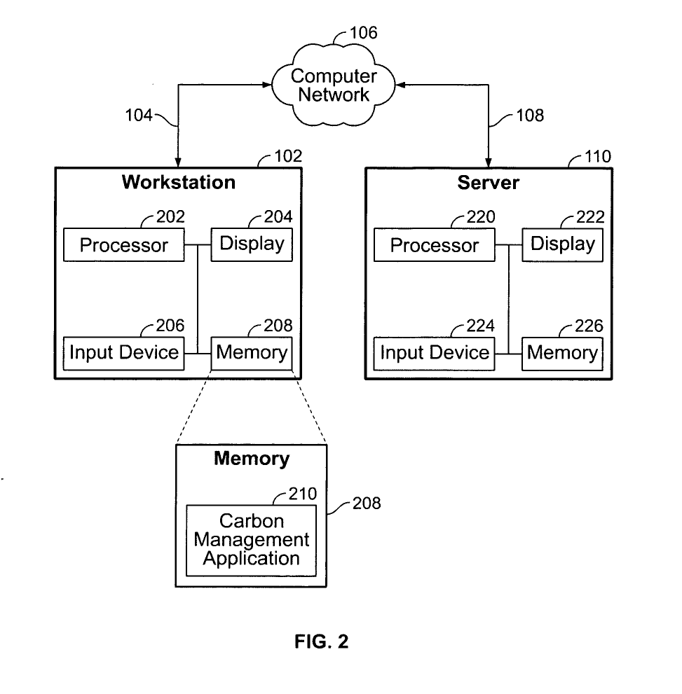

The server and one of the workstations, which are depicted in FIG. 1, are illustrated in more detail in FIG. 2. Referring to FIG. 2, workstation 102 may include processor 202, display 204, input device 206, and memory 208, which may be interconnected. In a preferred embodiment, memory 208 contains a storage device for storing a workstation program for controlling processor 220. Memory 226 also preferably stores a carbon management application 210 according to the invention.

Carbon management application 210 may preferably include an application program interface (not shown), or alternatively, as described above, carbon management application 210 may be resident in the memory of server 110. In some embodiments, carbon management application 210 and an application program interface may be part of an electronic trading application as an application discrete from the electronic trading application. The only distribution to the buyer or customer may then be a Graphical User Interface which allows the buyer or customer to interact with carbon management application 210 resident at server 110.

Processor 202 uses the workstation program to present on display 204 the carbon management application and trading information relating to emission reduction benefits received through communication link 104 and trading commands and values transmitted by a buyer or customer of workstation 102. Furthermore, input device 206 may be used to manually enter commands and values in order for these commands and values to be communicated to the carbon management application.

Server 110 may include processor 220, display 222, input device 224, and memory 226, which may be interconnected. In a preferred embodiment, memory 226 includes a storage device for storing information relating to carbon trading conditions received through communication link 108 or through other links, and also receives trading commands and values transmitted by one or more traders. The storage device further contains a server program for controlling processor 220. Processor 220 uses the server program to transact the purchase and sale of the emission reduction benefits and their associated emission retirement guarantees.

It should be noted that the present invention is primarily described herein in terms of a carbon management application. It will be understood that the carbon management application may be any suitable software, hardware, or both configured to implement the features of the present invention. In one suitable approach, the carbon management application may be located at a central location (e.g., a central server at a warehouse). In another suitable approach, the carbon management application may reside among different locations (e.g., a network).

In one particular embodiment, the carbon management application may include client-side software, hardware, or both. For example, the carbon management application may encompass one or more Web-pages or Web-page portions (e.g., via any suitable encoding, such as HyperText Markup Language (HTML), Dynamic HyperText Markup Language (DHTML), Extensible Markup Language (XML), JavaServer Pages (JSP), Active Server Pages (ASP), Cold Fusion, or any other suitable approaches).

Although the carbon management application is described herein as being implemented on user computer equipment, this is only illustrative. The carbon management application may be implemented on any suitable platform (e.g., personal computer (PC), mainframe computer, dumb terminal, data display, two-way pager, wireless terminal, portable telephone, portable computer, palmtop computer, H/PC, automobile PC, laptop computer, personal digital assistant (PDA), combined cellular phone and PDA, etc.) to provide such features.

Buyers at workstations 102 may participate in the electronic carbon trading by providing trading information and by otherwise interacting with the carbon management application. The carbon management application may provide a buyer at workstation 102 with screens containing various carbon trading information. For example, the buyer may be presented with screens that allow the buyer to make trades, view and update any suitable information relating to the buyer, or any other suitable screen in connection with carbon trading.

The carbon management application may provide the buyer or any other suitable user with interactive screens containing menus and selectable options that allow the buyer to navigate through the carbon management application and participate in the carbon management application. With workstation 102, the buyer may use a keyboard, mouse, trackball, touch pad, or other suitable input or pointing device to navigate the various menus and selectable options.

The buyer may access the carbon management application with workstation 102. The buyer may access the carbon management application by, for example, browsing to an Internet web site or a site on a private network, by running a local program, or any other suitable method. In some embodiments, when the carbon management application is part of an electronic trading application, the buyer may interact with the carbon management application by accessing the electronic trading application.

Marketing agents and brokers may interact with the carbon management application in substantially the same manner as buyers. The carbon management application may, however, provide marketing agents and brokers with access to additional functions of the carbon management application so that marketing agents and brokers may perform administrative tasks. For example, a marketing agent may input information relating to a prospective buyer.

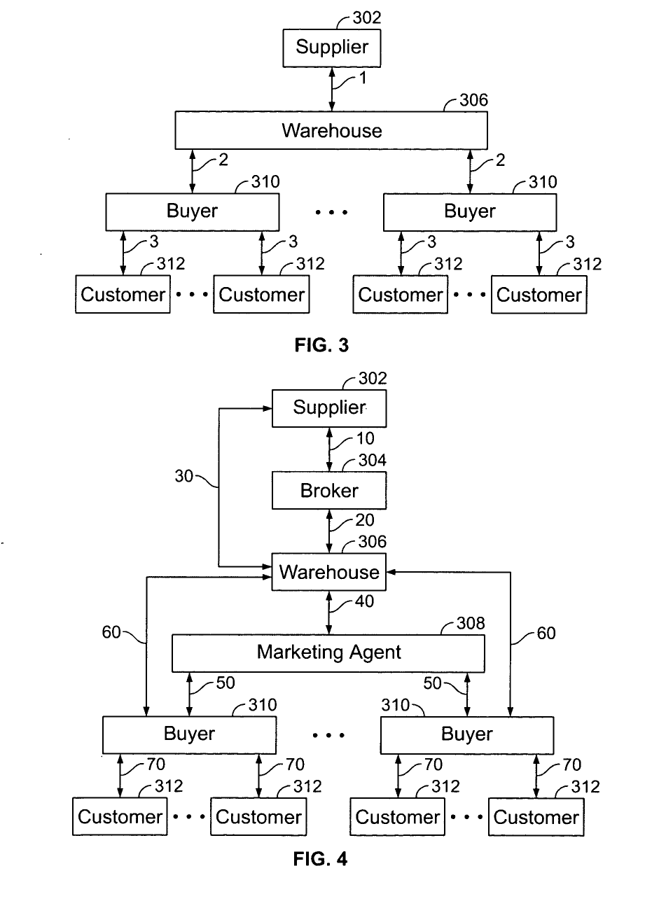

FIG. 3 shows an example of a transaction flow in accordance with one embodiment of the present invention. As shown, at step 1, a warehouse 306 may communicate with a supplier 302. Warehouse 306 may assess supplier 302 and the supplier's operation. In response to assessing supplier 302, warehouse 306 may propose an emission reducing project to supplier 302. For example, if supplier 302 has a coal mining operation, warehouse 306 may suggest that supplier 302 install scrubbers or an air filtration system into the coal mine to prevent such CO₂e emissions from entering the environment. In some embodiments, warehouse 306 may offer to support or find support for the emission reducing project in order to obtain the emission reduction benefits from the emission reducing project. As described previously, an emission reduction benefit is a quantity of environmental value generated from an emission reducing project.

In response to supplier 302 performing the emission reducing project, warehouse 306 may store the emission reduction benefits. For example, supplier or any other suitable entity may provide warehouse 306 with a certificate. The certificate may include, for example, the number of emission reduction benefits that corresponds to the emission reducing project. Warehouse 306 may input the corresponding number of emission reduction benefits from the emission reducing project and any other suitable information relating to the emission reduction benefits into the carbon management application.

Emission reduction benefits may be obtained by a warehouse using any suitable approach, but are described herein primarily in the context of transferring or storing emission reduction benefits resulting from a supplier's emission reducing project to a warehouse for specificity and clarity. Any other suitable approach may also be used, for example, the carbon management application may allow the warehouse to provide a standard contract to the supplier. The standard contract may be executed by the supplier agreeing that a specific amount of emission reduction benefits are assigned to the warehouse in exchange for supporting the emission reducing project.

The emission reduction benefits purchased by warehouse 306 from supplier 302 are preferably divided into smaller volumes and provided to multiple buyers and/or customers. For example, a warehouse may purchase fifty thousand tons of emission reduction benefits from a supplier. The supplier preferably provides the warehouse with a certificate corresponding to the fifty thousand tons of emission reduction benefits from that particular emission reducing project. The fifty thousand tons may be divided by warehouse 306 into any suitable amount and sold to buyers and/or customers. For example, a buyer may purchase one thousand tons of the fifty thousand tons of emission reduction benefits to make their product emissions neutral. In another suitable example, during the purchase of an airline ticket, a customer may purchase a single ton of the fifty thousand tons of emission reduction benefits in order to make their purchase emission neutral, thereby offsetting the emissions generated by their flight.

In some embodiments, the emission reduction benefits may be verified by an auditor, regulatory agency, or any other suitable entity. The auditor may ensure that warehouse 306 properly inputs the number of emission reduction benefits received. The auditor may also ensure that warehouse 306 retires the emission reduction benefits that are sold to buyers. For example, an auditor may validate that warehouse 306 is retiring the emission reduction benefits and are not selling the same emission reduction benefits to more than a single buyer or issuing multiple emission retirement guarantees for the same emission reduction benefits.

At step 2, warehouse 306 may market, sell, and manage the emission reduction benefits that are stored in warehouse 306 to one or more buyers 310. Warehouse 306 may, for example, present an offer to a buyer 310. In some embodiments, warehouse 306 may also prepare a customized presentation tailored to buyer 310 and the buyer's industry.

In some embodiments, warehouse 306 may use the carbon management application to present the concept of emission neutrality to buyer 310 by using the carbon management application. Using the carbon management application, warehouse 306 may present buyer 310 with, for example, emission reducing projects that warehouse 306 currently owns, emission reducing projects that may be purchased by warehouse 306 (e.g., projects in the pipeline), and information relating to the emission reducing projects. Using the carbon management application, warehouse 306 may provide buyer 310 with an electronic (e.g., an e-mail, a pop-up window, or any other suitable electronic notification) or printed notification. The notification may describe, for example, available emission reducing projects, emission reducing projects that buyer 310 may be interested in, emission reduction benefits associated with the available projects, the concept of emissions neutrality, and an approach for obtaining emission neutral products, services, and/or processes.

In response to the carbon management application distributing the notification to buyer 310, buyer 310 may contact warehouse 306 by using the carbon management application. Buyer 310 may purchase a particular number of emission reduction benefits in order to make their products, services, and/or processes emissions neutral. In some embodiments, buyer 310 may set up an account with the carbon management application in order to purchase such emission reduction benefits from warehouse 306.

In response to setting up an account, warehouse 306 may determine the price associated with the emission reduction benefits for buyer 310. In some embodiments, warehouse 306 may define a basket of emission reduction benefits suitable for buyer 310. The carbon management application may allow warehouse 306 to track buyer 310 and how buyer 310 interacts with warehouse 306. In response to buyer 310 engaging in a transaction with warehouse 306 (e.g., buyer 310 is purchasing an emission retirement guarantee from warehouse 306), warehouse 306 may assist buyer 310 in purchasing the emission retirement guarantee. For example, when buyer 310 purchases an emission retirement guarantee from warehouse 306, the carbon management application may generate an electronic (e.g., an e-mail, a pop-up window, or any other suitable electronic notification) or printed emission retirement guarantee for buyer 310. The emission retirement guarantee may include information relating to the transaction, such as, for example, volume, price, emission reducing projects and the associated emission reduction benefits, date, total price, or any other suitable transaction information. The emission retirement guarantee may also state that the associated emission reduction benefits are “put beyond use” and may not be sold, used for compliance, or used for any other purpose. Such an emission retirement guarantee may be used to provide buyer 310 with a confirmation of the purchase.

In response to buyer 310 purchasing an emission retirement guarantee by paying the appropriate fee, warehouse 306 preferably retires the emission reduction benefits corresponding to the emission retirement guarantee, thereby preventing the emission reduction benefits from being repurchased by another buyer.

In response to buyer 310 receiving an emission retirement guarantee from warehouse 306, buyer 310 may use the emission retirement guarantee to offset CO₂e emissions generated by the buyer's products, services, and/or processes. In some embodiments, buyer 310 may purchase a specific volume of emission retirement guarantees such that buyer 310 may make their products, services, and/or processes emissions neutral.

In some embodiments, warehouse 306 may determine the volume of emission retirement guarantees that buyer 310 has to purchase in order to become emissions neutral. For example, warehouse 306 may assess the buyer's products, services, and/or processes and determine the amount of CO₂e emissions generated. Warehouse 306 may input the assessment of the buyer's products, services, and/or processes into the carbon management application. When buyer 310 purchases a specific volume of emissions retirement guarantees such that the buyer's products, services, and/or processes are emission neutral, the carbon management application may generate an electronic or printed notification to buyer 310 indicating that buyer 310 has become emissions neutral.

In response to becoming emission neutral, buyer 310 may advertise to a customer 312 that buyer 310 and its associated products, services, and/or processes are emission neutral. Advertising emission neutrality may be sufficient enough to attract customer 312 into purchasing a product or service from buyer 310.

In some embodiments, the carbon management application may provide customer 312 with an opportunity to make their purchase emissions neutral. For example, at the point of sale (e.g., checkout), the carbon management application may provide customer 312 with a button or any other suitable graphical user interface to purchase an emission retirement guarantee.

Warehouse 306 may provide one or more customers 312 with access to the carbon management application. The carbon management application may provide a customer 312 with an opportunity to create or set up an account or access an existing account. For example, the carbon management application may prompt customer 312 for the customer's full name, address, telephone number(s), e-mail address, credit card information, and any other suitable information for use by the carbon management application. In addition, the carbon management application may provide the user with an opportunity to set up or access personal information, saved lists, or other features of the carbon management application.

In response to accessing the account, the carbon management application may provide customer 312 with an opportunity to search for available emission reducing projects. The carbon management application may, for example, provide customer 312 with an opportunity to input keywords. In response to inputting a keyword, the carbon management application may search for matching items or filter out items that do not match the keywords. In another suitable approach, the carbon management application may provide customer 312 with opportunities to search for desired emission reducing projects by selecting topics. For example, emission reducing projects or emission reduction benefits may be organized by location, type of reduction, price, volume, or any other suitable criteria. Any other suitable interface element (such as a menu selection, link, button, or other interface element) or suitable searching paradigm may also be used.

Using any suitable interface element, the carbon management application may provide customer 312 with access to additional information relating to a particular emission reducing project, such as a detailed project plan, comments from the supplier discussing the project, or any other suitable information. The additional information may include any suitable content, such as text, graphics, video, audio, animations, or any other suitable content.

In some embodiments, the carbon management application may provide customer 312 with access to personalized information relating to the customer. For example, the carbon management application may provide the user with a list of all previously retired emission reduction benefits, a list of emission reduction benefits retired by the customer, a list of emission reducing projects from which the customer has purchased an emission reduction benefit, and any other suitable information.

The carbon management application may also provide customer 312 with an opportunity to make their purchase emissions neutral. The carbon management application may provide customer 312 with any suitable interface element, such as a button (not shown), for indicating the customer's desire to make their purchase emissions neutral. In response to customer 312 selecting the button or any other suitable interface element, the carbon management application may provide customer 312 with, for example, a quote based on the volume of emission reduction benefits needed to make the purchase emissions neutral. For example, when customer 312 is purchasing an airline ticket, customer 312 may be provided with an option to charge twenty dollars in addition to the original airline ticket in order to make the purchase emission neutral. In response to purchasing the emission reduction benefit, warehouse 306 or buyer 310 preferably provides customer 312 with an emission retirement guarantee. As stated previously, the emission retirement guarantee may state the number of emission reduction benefits that are retired from a particular emission reducing project and that the associated emission reduction benefits are “put beyond use” and may not be sold, used for compliance, or used for any other purpose.

FIG. 4 shows another example of a transaction flow in accordance with one embodiment of the present invention. As shown, at step 10, a warehouse 306 using the carbon management application may allow a broker 304 to assess a supplier 302 and the supplier's operation. In particular, broker 304 may evaluate the supplier's operation and propose an emission reducing project to supplier 302. In some embodiments, broker 304 may offer to support the emission reducing project in order to obtain emission reduction benefits. In some embodiments, broker 304 may locate a warehouse 306 that would support the emission reducing project in order to obtain emission reduction benefits.

At step 20, warehouse 306 may use broker 304 to assist warehouse 306 in obtaining emission reduction benefits. In some embodiments, broker 304 may contact warehouse 306 when broker 304 has located a potential supplier that has available emission reduction benefits. In this example, warehouse 306 may purchase emission reduction benefits from the emission reducing project of supplier 302. The amount of emission reduction benefits stored in warehouse 306 may be determined based on the size of the transaction with supplier 302 (e.g., how much warehouse 306 contributes to the emission reducing project). At step 30, in exchange for purchasing emission reduction benefits from the emission reducing project (e.g., by providing a payment to the supplier for at least a portion of the emission reducing project), supplier 302 may transfer the resulting emission reduction benefits to warehouse 306. For example, supplier 302 may provide warehouse 306 with a certificate that includes the number of emission reduction benefits resulting from one or more emission reducing projects.

As discussed previously, the emission reduction benefits may be verified by an auditor, regulatory agency, or any other suitable entity. The auditor may ensure that warehouse 306 and/or broker 304 properly inputs the number of emission reduction benefits received. The auditor may also ensure that emission retirement guarantees have been issued for the emission reduction benefits that are being offered to buyers. It should also be noted that emission reduction benefits may be obtained using any suitable approach, but are described herein primarily in the context of transferring or storing emission reduction benefits resulting from a supplier's emission reducing project to a warehouse for specificity and clarity. Any other suitable approach may also be used. For example, the carbon management application may allow the warehouse to provide a standard contract to the supplier. The standard contract may be executed by the supplier agreeing that a specific amount of emission reduction benefits are assigned to the warehouse in exchange for supporting the emission reducing project.

As shown in step 40, warehouse 306 may use a marketing agent 308 to market, sell, and manage the emission reduction benefits stored in warehouse 306. In particular, marketing agent 308 may propose a marketing approach to warehouse 306 and identify potential buyers. Such a marketing approach may include an approach for presenting an offer to a buyer 310. For example, marketing agent 308 may suggest sending a particular advertisement via e-mail to buyer 310. In another example, marketing agent 308 may suggest preparing a customized presentation tailored to buyer 310 and the buyer's industry.

If marketing agent 308 and warehouse 306 agree on the proposed approach, warehouse 306 or marketing agent 308 may use the carbon management application to generate an electronic (e.g., an e-mail, a pop-up window, or any other suitable electronic notification) or printed notification for buyer 310 at step 50. The notification may describe available emission reducing projects, emission reducing projects that buyer 310 may be interested in, emission reduction benefits associated with the available projects, the concept of emissions neutrality, and an approach for making their products, services, and/or processes emissions neutral.

In response to the carbon management application distributing the notification to buyer 310, buyer 310 may contact marketing agent 308 in order to make their products, services, and/or processes emissions neutral in any suitable manner. For example, marketing agent 308 may assist buyer 310 in setting up an account. In another example, marketing agent 308 may set up an account for buyer 310.

In response to setting up an account, marketing agent 308 may determine the price associated with the emission reduction benefits for buyer 310. In some embodiments, marketing agent 308 may define a basket of emission reduction benefits suitable for buyer 310. Marketing agent 308 may use the carbon management application to present the concept of emission neutrality to buyer 310 by using the carbon management application to present the buyer with, for example, emission reducing projects that the warehouse currently owns, emission reducing projects that may be purchased by the warehouse (e.g., projects in the pipeline), and information relating to the emission reducing projects.

Based on the information inputted into the carbon management application by warehouse 306, broker 304, marketing agent 308, and buyer 310, the carbon management application may also allow marketing agent 308 and warehouse 306 to track buyer 310 and how buyer 310 interacts with warehouse 306. At step 60, in response to buyer 310 engaging in a transaction with warehouse 306 (e.g., buyer 310 is purchasing an emission retirement guarantee from warehouse 306), warehouse 306 may direct marketing agent 308 to assist buyer 310 in purchasing the emission retirement guarantee. For example, when buyer 310 purchases the emission retirement guarantee from warehouse 306, the carbon management application may generate an electronic (e.g., an e-mail, a pop-up window, or any other suitable electronic notification) or printed emission retirement guarantee for buyer 310. The emission retirement guarantee may include information relating to the transaction, such as, for example, volume, price, emission reducing projects and the associated emission reduction benefits, date, total price, or any other suitable transaction information. The emission retirement guarantee may also state that the associated emission reduction benefits are “put beyond use” and may not be sold, used for compliance, or used for any other purpose. Such an emission retirement guarantee may be used to provide buyer 310 with a confirmation of the purchase. In some embodiments, the carbon management application may also notify marketing agent 308 of the purchase.

In some embodiments, warehouse 306 may sell the emission reduction benefits to marketing agent 308 at a specific price (e.g., at a wholesale price). Marketing agent 308 may continue to sell emission retirement guarantees (i.e., the retirement of emission reduction benefits) to buyer 310. In response to buyer 310 purchasing an emission retirement guarantee by paying the appropriate fee, marketing agent 308 may notify warehouse 306 to retire the emission reduction benefits corresponding to the emission retirement guarantee, thereby preventing the emission reduction benefits from being repurchased.

In response to buyer 310 purchasing an emission retirement guarantee from warehouse 306, buyer 310 may use the emission retirement guarantee to offset CO₂e emissions generated by the buyer's products, services, and/or processes. In some embodiments, buyer 310 may purchase a specific volume of emission retirement guarantees such that buyer 310 may provide products, services, and/or processes that are emission neutral.

In some embodiments, warehouse 306 or marketing agent 308 may determine the volume of emission retirement guarantees that buyer 310 has to purchase in order to become emissions neutral. For example, the carbon management application may assess the buyer's products, services, and/or processes and determine the amount of CO₂e emissions generated. When buyer 310 purchases a specific volume of emissions retirement guarantees such that the buyer's products, services, and/or processes are emission neutral, the carbon management application may generate an electronic or printed notification to buyer 310 indicating that buyer 310 has become emissions neutral.

In response to becoming emission neutral, buyer 310 may advertise to a customer 312 that buyer 310 and its associated products, services, and/or processes are emission neutral. Advertising emission neutrality may be sufficient enough to attract customer 312 into purchasing a product or service from buyer 310.

As described previous in FIG. 3, the carbon management application may provide customer 312 with an opportunity to make their purchase emissions neutral by purchasing an emission reduction benefit from warehouse 306 or buyer 310. For example, at the point of sale (e.g., checkout), the carbon management application may provide customer 312 with a button or any other suitable graphical user interface. In response to selecting the button, the carbon management application may provide customer 312 with, for example, a quote based on the volume of emission reduction benefits needed to make the purchase emissions neutral. For example, when customer 312 is purchasing an airline ticket, customer 312 may be provided with an option to charge twenty dollars in addition to the original airline ticket in order to make the purchase emissions neutral.

Although not shown in the transaction flows of FIGS. 3 and 4, underlying each step, the carbon management application tracks and reconciles the progress of buyer 310 and customer 312 in purchasing emission retirement guarantees from warehouse 306 and the transfer of emission reduction benefits from supplier 302 to warehouse 306. This may include, for example, keeping track of the number of notifications sent out to buyers, the number of responses to those notifications from buyers, the number of buyers that purchased emission retirement guarantees in response to those notifications, the total value of those transactions, the fees owed to supplier 302, broker 304, warehouse 306, and marketing agent 308, in connection with offering, tracking, and selling emission reduction benefits and emission retirement guarantees in accordance with the present invention. The carbon management application may then present this tracked information to supplier 302, broker 304, warehouse 306, and/or marketing agent 308 for the purpose of providing information, for the purpose of billing them for services rendered, paying them for services rendered (e.g., the warehouse automatically credits or deposits a payments into the marketing agent's account), or for any other suitable or desired purpose.

In some embodiments, warehouse 306 uses marketing agent 308 to provide a customer support function to the extent that a buyer or a customer has questions, concerns, and/or problems with receiving information for emission reducing projects and their corresponding emission reduction benefits or purchasing emission retirement guarantees.

The carbon management application may provide warehouse 306, broker 304, marketing agent 308, buyer 310, customer 312, and any other suitable user or trader with interactive displays containing menus and selectable options that allow them to navigate through the carbon management application. Warehouse 306, broker 304, marketing agent 308, buyer 310, customer 312, and any other suitable user may interact with the carbon management application using workstation 102. The carbon management application may be accessed by browsing to an Internet web site or a site on a private network, by running a local program, or by any other suitable approach.

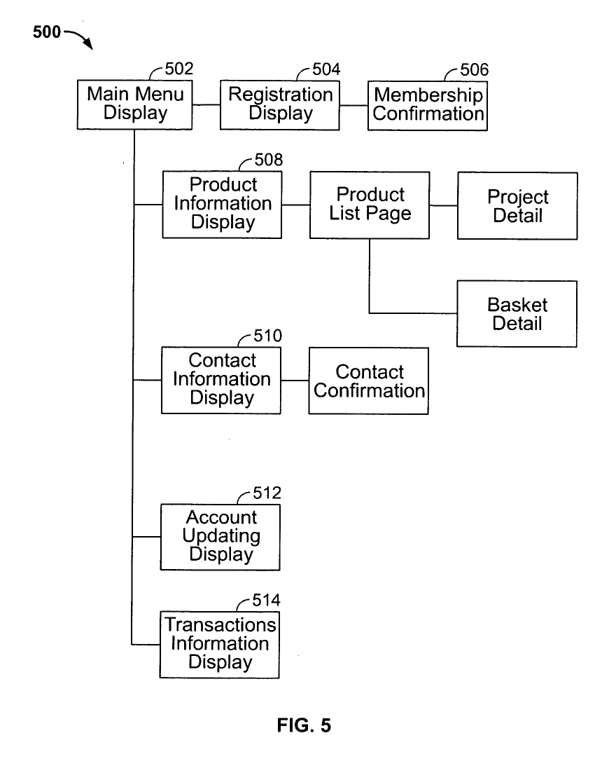

FIGS. 5-8 show illustrative site maps 500, 600, 700, and 800, respectively, of the carbon management application in accordance with some embodiments of the present invention.

In FIGS. 5-8, the carbon management application may provide a buyer, a marketing agent, a warehouse, and a customer, respectively, with multiple features. Each of site maps 500, 600, 700, and 800 shows that the carbon management application may provide a main menu display 502 (e.g., a home page). The carbon management application may provide main menu display 502 when a user (e.g., a buyer, a marketing agent, a warehouse, or a customer) initially accesses the carbon management application. However, to access displays provided by the carbon management application that are reserved for registered user only, the user may need to log onto the carbon management application or register to become a member.

As shown, the carbon management application may provide each user in FIGS. 5-8 with a registration display 504 that may allow the user to register. Registration display 504 may prompt the user to input information relating to the user, such as, for example, name, address, telephone number, type of user (e.g., buyer, marketing agent, warehouse, etc.), or any other suitable user information.

Main menu display 502 may also provide the user with a log on area. The log on area may include a username text box and a password text box. When the user inputs a valid username and password, the carbon management application may determine the type of user: buyer, marketing agent, warehouse, retailer, supplier, customer, or public access. Based on the determination, the carbon management application may provide users with various levels of access to the carbon management application.

FIG. 5 shows an illustrative site map 500 that may be provided to a buyer by the carbon management application in accordance with some embodiments of the present invention. From site map 500, the buyer may access trading tools and options related to CO₂e emission reductions and emission reduction benefits. As shown in site map 500, the carbon management application may provide the buyer with a product information display 508, a contact information display 510, an account updating display 512, and a transactions information display 514.

Product information display 508 may include an introductory description of the carbon management application, emission reducing projects, and emission reduction benefits. Product information display 508 may also include a listing of emission reducing projects that the warehouse currently owns, emission reducing projects that may be purchased by the warehouse (e.g., projects in the pipeline), and information relating to each of the emission reducing projects. In response to the buyer selecting one of the projects from the listing, the carbon management application may provide the buyer with a detailed description of the selected emission reducing project. The detailed description may include, for example, project name, project description, project location, project type (e.g., area of technology), emission reduction benefits available (e.g., by vintage year), emission reduction benefits purchased, retired emission reduction benefits, retail price (e.g., by vintage year as determined by a marketing agent), and any other suitable information relating to the emission reducing project. The detailed description for a project that may be purchased by the warehouse may also include, for example, project location, project type, project description, and expected volume.

In some embodiments, the carbon management application may provide a buyer with a list of available baskets. In response to the buyer selecting one of the available baskets, the carbon management application may provide the buyer with detailed basket information. Detailed basket information may include, for example, a breakdown of the basket make-up (e.g., by percentage, by absolute volume, etc.) and the price for each basket year (i.e., a weighted average based on the basket make-up).

Contact information display 510 may provide the buyer with, for example, contact information for the marketing agent and contact information for the warehouse. Display 510 may also provide the buyer with a messaging interface. The messaging interface may allow the buyer to submit a question to, for example, an administrator of the carbon management application.

Update my account display 512 may allow the buyer to manage the buyer's account. For example, the buyer may change the buyer's username, password, address information, or any other suitable user information.

Transactions information display 514 may provide the buyer with a list of transactions executed by the buyer. In response to the buyer selecting one of the transactions, the carbon management application may provide the user with detailed transaction information. The detailed transaction information may include, for example, date of purchase, emission reducing project purchased, total volume purchased, per unit price, and total price. The detailed transaction information may also include hyperlinks to a detailed description of the purchased emission reducing project.

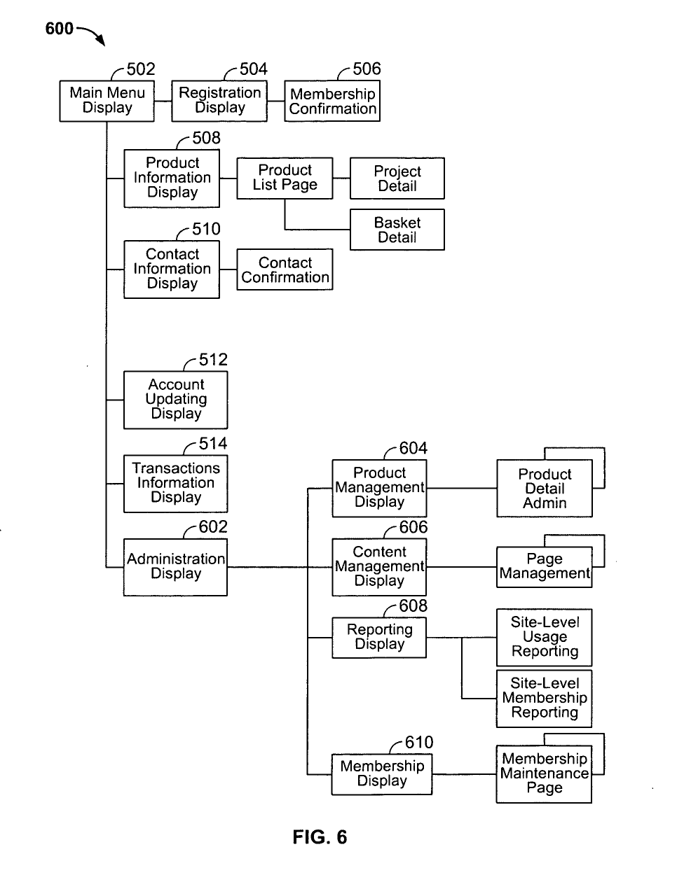

FIG. 6 shows an illustrative site map 600 that may be provided to a marketing agent by the carbon management application in accordance with some embodiments of the present invention. As shown in FIG. 6, the carbon management application provides the marketing agent with access to similar trading tools and options related to CO₂e emission reductions as buyers (FIG. 5). For example, the carbon management application may provide transactions information display 514 that allows the marketing agent to view transactions for all of their buyers. In another example, the carbon management application may provide update my account display 512 that allows the marketing agent to create and maintain accounts for potential buyers.

The carbon management application also provides the marketing agent with access to administrative display 602. Administrative display 602 may provide the marketing agent with links to a products management display 604, a content management display 606, a reporting display 608, and a membership display 610.

In response to the marketing agent selecting the link to a products management display 604, the carbon management application may provide the marketing agent with a display that allows the marketing agent to manage information that is presented to buyers. Products management display 604 may provide the marketing agent with the ability to select specific emission reducing projects and/or baskets that may be presented to a particular buyer. For example, the carbon management application may allow the marketing agent to select a particular buyer and input product information, such as the name of the emission reduction project, wholesale price for the project, and retail price for the project. In response, the carbon management application may provide the particular buyer with the product listing in product information display 508.

In some embodiments, the carbon management application may allow the marketing agent to create baskets of emission reducing projects for the particular buyer. For example, the carbon management application may allow the marketing agent to select from a list of available emission reducing projects. In response to selecting one or more projects, the marketing agent may determine the composition of the basket, thereby allowing the marketing agent to create a basket that corresponds with a particular buyer's industry, location, or interests.

Referring back to administrative display 602, the marketing agent may also select a link to content management display 606. In response to selecting the link, the carbon management application may provide the marketing agent with a display that allows the marketing agent to modify the content of the carbon management application for the marketing agent's buyers and customers. For example, the marketing agent may customize the carbon management application to include, for example, the logo of the marketing agent. The marketing agent may modify the carbon management application to include any suitable passive or interactive text, graphics, audio, video, animation, or other suitable content.

When the marketing agent selects a link from administrative display 602 to reporting display 608, the carbon management application may provide the marketing agent with the ability to view reports relating to the carbon management application. For example, reporting display 608 may include a site level usage report and a site level membership report. The site level usage report may provide the marketing agent with a list of buyers and customers using the carbon management application. The site level membership report may, for example, provide the marketing agent with a list of buyers using the marketing agent and their corresponding membership details.

When the marketing agent selects a link from administrative display 602 to membership display 610, the carbon management application may provide the marketing agent with the ability to create accounts for new or potential buyers. Membership display 610 may prompt the marketing agent to include buyer information, such as, for example, the buyer's company name, contact information, e-mail address, username, password, or any other suitable buyer information. In response to inputting buyer information, the carbon management application may register the buyer. The marketing agent may then use displays 604 and 606 to tailor product information display 608 that is presented to the registered buyer.

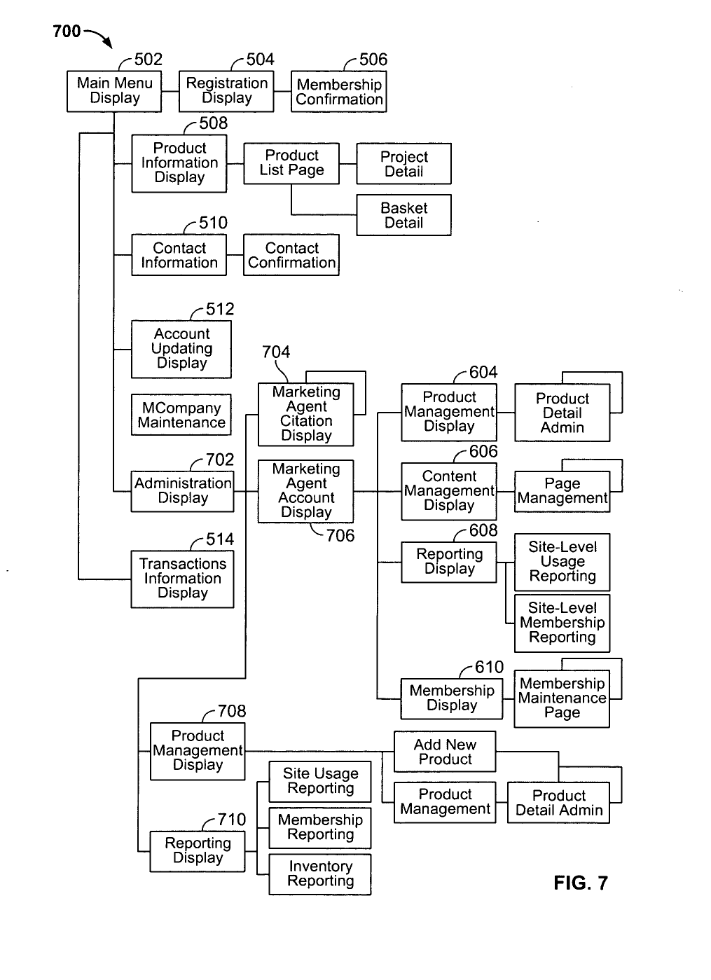

FIG. 7 shows an illustrative site map 700 that may be provided to a warehouse by the carbon management application in accordance with some embodiments of the present invention. As shown in FIG. 7, the carbon management application provides the warehouse with access to similar trading tools and options as the marketing agent related to CO₂e emission reductions as buyers (FIG. 5) and marketing agents (FIG. 6). For example, the carbon management application may provide transactions information display 514 that allows the warehouse to view transactions for all of their marketing agents.

Similar to how a marketing agent may use the carbon management application to entice buyers to purchase emission retirement guarantees, the warehouse may use the carbon management application to attract marketing companies to market and manage the warehouse's emission reduction benefits. In some embodiments, the warehouse may also use the carbon management application to attract buyers in purchasing emission retirement guarantees and their corresponding emission reduction benefits. In some embodiments, the warehouse may provide the buyers with marketing agents to assist the buyers throughout the purchasing process.

In addition to the displays accessible to buyers and marketing agents, the carbon management application may also provide the warehouse with an administration display 702. Administration display 702 may provide the warehouse with links to a marketing agent creation display 704, a marketing agent account display 706, a product management display 708, and a reporting display 710.

In response to the warehouse selecting a link to marketing agent creation display 704, the carbon management application may allow the warehouse to add and register a marketing agent. The warehouse may be prompted to input information relating to the marketing agent, such as, for example, a name, contact information, and a website name for the marketing agent (e.g., www.futureforest-wh.com). Marketing agent creation display 704 may also allow the warehouse to assign available emission reducing projects to the marketing agent. For example, the warehouse may select from a list of available emission reducing projects that the marketing agent will be responsible for marketing and selling. In some embodiments, the warehouse may select from a list of potential buyers and/or customers that the marketing agent will be responsible for, for example, assisting them with their purchases, providing them with presentations, customizing baskets of emission reducing projects, or any other suitable function.

In response to the warehouse selecting a link to marketing agent account display 706, the carbon management application may provide the warehouse with a display that prompts the user to select from a list of marketing agents. In response to the warehouse selecting one of the marketing agents, the carbon management application may provide the warehouse with displays and links to displays that are managed by the selected marketing agent. As shown in FIG. 7, the warehouse may have access to product management display 604, content management display 606, reporting display 608, and membership display 610 for each marketing agent.

In response to the warehouse selecting a link to product management display 708, the carbon management application may provide the warehouse with a display that allows the warehouse to manage their emission reduction benefits. For example, in response to storing emission reduction benefits from an emission reducing project (e.g., from a supplier), the warehouse may input information relating to the emission reducing project and the number of emission reduction benefits resulting from the project. Such information may include, for example, a description of the project, a list of buyers and customers that have purchased emission retirement guarantees for that project, a list of baskets that the project is grouped with, or any other suitable information relating to the emission reducing project.

In another example, when a marketing agent sells an emission retirement guarantee to a buyer, the marketing agent may use the carbon management application to send a notification to the warehouse of the sale. In response, the warehouse may access product management display 708 to update the available number of emission reduction benefits. For example, the warehouse may retire a specified number of emission reduction benefits by inputting the number of emission reduction benefits and changing their status from “active” to “retired.” By changing the status to retired, the warehouse prevents those benefits from being repurchased.

In some embodiments, the carbon management application may automatically reconcile the warehouse's emission reduction benefits in response to a buyer purchasing an emission retirement guarantee. In some embodiments, an independent auditor may ensure that the warehouse properly inputs the number of emission reduction benefits purchased and retired, thereby preventing the sale of the same emission reduction benefits to another buyer or customer.

In response to the user selecting a link to reporting display 710, the carbon management application may provide the warehouse with a display that allows the warehouse to view reports relating to the carbon management application. As shown in FIG. 7, reporting display 710 may include a site level usage report, a membership report, and an inventory report. The site level usage report may, for example, provide the warehouse with a list of all users (e.g., marketing agents, buyers, customers, etc.) using the carbon management application. The membership report may, for example, provide the warehouse with a drop-down list that includes all marketing agents employed by the warehouse. In response to selecting one of the marketing agents, the membership report may provide the warehouse with a list of buyers corresponding to the marketing agent and their corresponding membership details. The inventory report may, for example, provide the warehouse with a listing of each emission reducing project, the corresponding emission reduction benefits that are available, and the number of emission reduction benefits that have been retired.

In some embodiments, the carbon management application may provide project ratings for a warehouse's emission reducing projects and their corresponding stored emission reduction benefits. Project ratings may be based on, for example, the number of times a buyer or a customer views a project, the number of times a buyer or a customer purchases a project, or any other suitable approach. For example, identifiers are received by, for example, the carbon management application when a buyer views a particular emission reducing project. Identifiers may be used by, for example, the carbon management application to indicate what emission reducing projects or emission reduction benefits are being viewed. Any other suitable approach may be used for detecting access to particular emission reducing projects or benefits.

Additional ratings may be assigned each time the emission reducing project is viewed. The use of a graded approach may enable, for example, the carbon management application to account for buyers or customers that view emission reducing projects multiple times. Grading information may be a point system. For example, the first viewing of the project is given a high rating. Upon determining grading information and a grading approach, the project ratings are calculated. By tracking and differentiating buyers and customers, the same buyer or customer viewing the same project multiple times may be taken into account. Graded approaches or any other suitable approaches may be used to calculate the project ratings.

Similar to how a buyer may use the carbon management application to purchase emission retirement guarantees for a portion of emission reduction benefits, a customer may use the carbon management application to purchase emission retirement guarantees. In some embodiments, the customer purchases an emission retirement guarantee along with a product or service in order to offset the emissions generated from the product or service. For example, during the purchase of an airline ticket, a customer may purchase a small unit of emission reduction benefits in order to make a portion of or all of their purchase emission neutral, thereby offsetting a portion or all of the emissions generated by their flight.

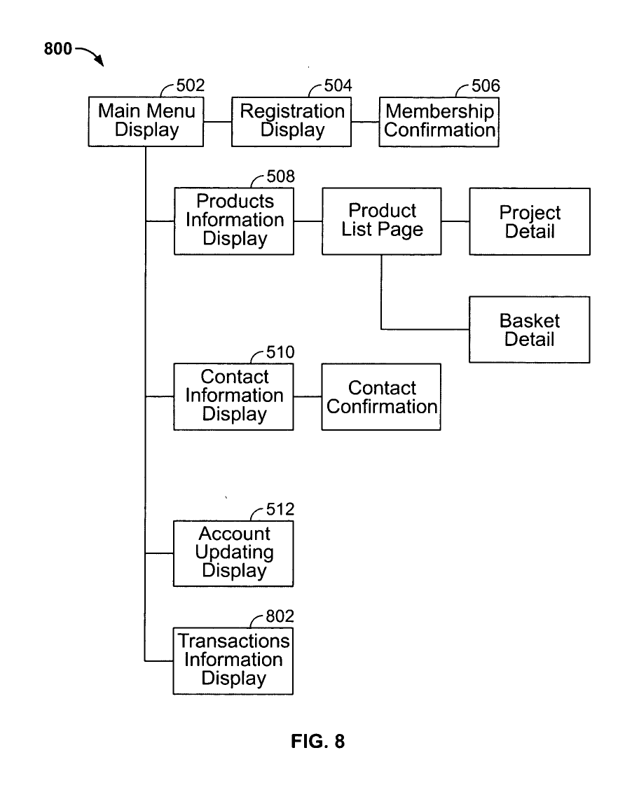

FIG. 8 shows an illustrative site map 800 that may be provided to a customer by the carbon management application in accordance with some embodiments of the present invention. As shown in FIG. 8, the carbon management application provides the customer with access to similar trading tools and options related to CO₂e emission reductions as buyers (FIG. 5). For example, the carbon management application may provide update my account display 512 that allows the customer to maintain their account (e.g., update password, update contact information, account status, etc.). The carbon management application may also provide contact information display 510. As discussed previously, contact information display 510 may provide the customer with contact information for one or more marketing agents and contact information for the warehouse. In some embodiments, contact information display 510 may provide the customer with an opportunity to select a marketing agent from a list of agents to assist the customer with their transactions.

The carbon management application also provides the customer with access to transactions information display 802. In some embodiments, transactions information display 802 may provide the customer with an opportunity to search for available emission reducing projects. The carbon management application may, for example, provide the customer with an opportunity to input keywords. In response to inputting a keyword, the carbon management application may search for matching items or filter out benefits or projects that do not match the keywords. In another suitable approach, the carbon management application may provide the customer with an opportunity to search for desired emission reducing projects by selecting topics. For example, emission reducing projects or emission reduction benefits may be organized by location, type of reduction, price, volume, or any other suitable criteria.

In some embodiments, transactions information display 802 may provide the customer with links to various products, services, and processes that the customer may purchase. The products, services, and processes listed on display 802 may include an option to purchase an emission reduction benefit along with the product, service, or process. For example, when a customer is purchasing an automobile on display 802, the carbon management application may provide the customer with an option to charge five hundred dollars in addition to the original price of the automobile to make the purchase emissions neutral. In response to the customer selecting the button, link, or any other suitable interface element, the carbon management application may provide the customer with, for example, a quote based on the volume of emission reduction benefits needed to make the purchase emissions neutral. In response to purchasing the emission reduction benefit along with the product, service, or process, the warehouse preferably provides the customer with an emission retirement guarantee.

Although not shown in FIGS. 5-8, the carbon management application may provide the users with the ability to search for available emission reducing projects or emission reduction benefits using any suitable approach. For example, a marketing agent may input keywords. In response to an inputted keyword, the carbon management application may provide a display that provide the user with matching emission reducing projects or filters out projects that do not match the keywords. In another suitable approach, the carbon management application may provide the user with the ability to select topics (e.g., brokerage, travel, etc.). Any other suitable interface element (such as a menu selection, hyperlink, button, or other interface element) or suitable searching paradigm may also be used.

Although also not shown in FIGS. 5-8, the carbon management application may provide buyers with the ability to purchase emission reduction benefits from multiple warehouses. For example, if a volume of emission reduction benefits is not available at a first warehouse, the carbon management application may allow a second warehouse to provide the volume of emission reduction benefits that the first warehouse cannot fulfill.

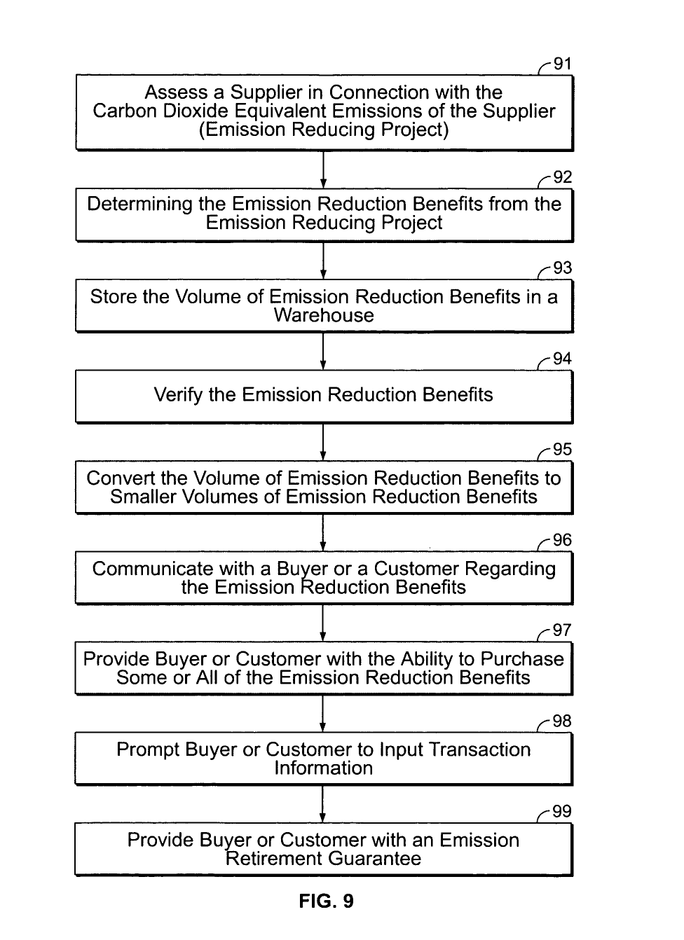

FIG. 9 is a flow chart of an illustrative method involved in allowing a warehouse to engage in a transaction with a supplier and a buyer in accordance with some embodiments of the present invention. This is a generalized flow chart. It will be understood that the steps shown in FIG. 9 may be performed in any suitable order, some may be deleted, and others added.

At step 91, the warehouse may assess a supplier in connection with the carbon dioxide equivalent emissions of the supplier. The assessment may include a suggestion for creating an emission reducing project to reduce the emissions of the supplier's operation. The assessment may be inputted by the warehouse into the carbon management application. In some embodiments, the assessment may be performed by a broker.

At step 92, carbon management application may receive an indication from the warehouse that an emission reducing project has been performed by a supplier. The warehouse may then determine the number of emission reduction benefits generated from the emission reducing project. In some embodiments, the warehouse may receive the emission reduction benefits in response to the purchasing or funding of the project. At step 93, in response to funding the supplier's emission reducing project or purchasing the emission reduction benefits from the supplier, the warehouse may store the emission reduction benefits. In one suitable example, the supplier or any other suitable entity may provide the warehouse with a certificate. The certificate may include, for example, the number of emission reduction benefits that corresponds to the emission reducing project. The number of benefits may be determined based amount of CO₂e that is removed from the environment as a result of the emission reducing project.

The warehouse may input the corresponding number of emission reduction benefits from the emission reducing project and any other suitable information relating to the emission reduction benefits into the carbon management application. In response to storing the emission reduction benefits in the warehouse, the emission reduction benefits may be verified by an auditor, regulatory agency, or any other suitable entity at step 94. The auditor may ensure that the warehouse properly inputs the number of emission reduction benefits received. The auditor may also ensure that the warehouse retires the emission reduction benefits that are sold to buyers. For example, an auditor may validate that the warehouse is retiring the emission reduction benefits and are not selling the same emission reduction benefits to more than a single buyer or issuing multiple emission retirement guarantees for the same emission reduction benefits.

At step 95, the emission reduction benefits purchased by the warehouse are preferably sold in smaller volumes to multiple buyers and/or customers. For example, a warehouse may purchase fifty thousand tons of emission reduction benefits from a supplier. The fifty thousand tons may be divided into smaller volumes of one ton to be sold to buyers and/or customers. That is, the warehouse may convert the volume of emission reduction benefits into multiple, smaller volumes of emission reduction benefits.

At step 96, the warehouse may use the carbon management application to communicate a notification of the available emission reducing projects and emission reduction benefits to buyers and/or customers. In some embodiments, the carbon management application may receive an indication from the warehouse to communicate the notification to a marketing agent. The marketing agent may then manage or assist a buyer or a customer with the sale of the emission reducing projects and emission reduction benefits to the buyer or the customer.

In response thereto, the carbon management application may provide the buyer or the customer with an opportunity to purchase some or all of the available emission reduction benefits at step 97. At step 98, in response to receiving a request to purchase available emission reduction benefits, the carbon management application may prompt the buyer or the customer to input transaction information. Transaction information may include, for example, the volume of emission reducing benefits, the agreed-upon price of the benefits, the name of the emission reducing project and the associated benefits, the date of the transaction, total price of the transaction, or any other suitable transaction information. Transaction information may also include information communicated to the marketing agent. In response to processing the request, the carbon management application may notify the warehouse of the transaction. Upon notifying the warehouse of the completion of the transaction, the carbon management application may provide the buyer or the customer with an emission retirement guarantee which indicates the purchase of a specific volume of emission reduction benefits and guarantees their retirement at step 99.

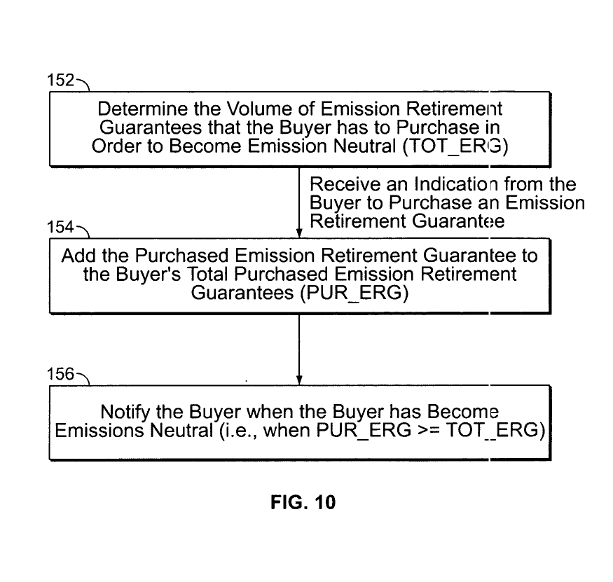

FIG. 10 is a flow chart of an illustrative method involved in allowing a buyer to provide emission neutral products, services, and/or processes to a customer in accordance with some embodiments of the present invention. In response to the buyer purchasing the emission retirement guarantee from the warehouse, the buyer may use the emission retirement guarantee to offset CO₂e emissions generated by the buyer's products, services, and/or processes. In some embodiments, the buyer may purchase a specific volume of emission retirement guarantees such that buyer may obtain products, services, and/or processes that are emission neutral.

The warehouse or any other suitable entity (e.g., an independent auditor, regulatory agency, etc.) may determine the volume of emission retirement guarantees that the buyer has to purchase in order for their products, services, or processes to be emissions neutral. At step 152, the carbon management application may provide the buyer with the determined volume of emission retirement guarantees that the buyer has to purchase in order to become emissions neutral. For example, the carbon management application may assess the buyer's products, services, and/or processes and determine the amount of CO₂e emissions generated.

As the buyer purchases volumes of emission retirement guarantees, the carbon management application tracks the amount of total emission retirement guarantees that the buyer has purchased at step 154. When the buyer has purchases a specific volume of emission retirement guarantees such that the buyer's products, services, and/or processes are emission neutral, the carbon management application may generate an electronic or printed notification to the buyer indicating that the buyer has become emissions neutral at step 156.

In response to becoming emission neutral, the buyer may advertise to a customer that the buyer and the buyer's associated products, services, and/or processes are emission neutral. Advertising emission neutrality may be sufficient enough to attract the customer into purchasing a product or service from the buyer.

Thus, electronic trading systems and methods for facilitating the creation of emission reducing projects and trading emission reduction benefits are provided. One skilled in the art will realize that the present invention can be practiced by other than the described embodiments, which are presented for purposes of illustration and not of limitation, and that the present invention is limited only by the claims which follow.

What is claimed is:

1. A method for providing emission reduction benefits using a carbon management application, the method comprising:
generating emission reduction benefits from an emission reducing project;
storing the emission reduction benefits in a warehouse;
verifying the stored emission reduction benefits; and
providing the emission reduction benefits to a plurality of buyers.

2. The method of claim 1, wherein the providing further comprises:
dividing the emission reduction benefits into a plurality of smaller benefits; and
providing the plurality of smaller benefits to a plurality of buyers.

3. The method of claim 1, wherein the generating further comprises:
assessing a supplier in connection with carbon dioxide equivalent emissions of the supplier;
creating the emission reducing project based at least in part on the assessment; and
converting the emission reducing project to a volume of emission reduction benefits.

4. The method of claim 1, wherein the emission reduction benefits are a basket of emission reduction benefits.

5. The method of claim 1, further comprising allowing a broker and the supplier to determine an approach for creating the emission reducing project.

6. The method of claim 1, wherein the providing further comprises allowing a marketing agent and the warehouse to determine an approach for providing the emission reduction benefits to the plurality of buyers.

7. The method of claim 1, wherein the storing further comprises providing the warehouse with a certificate that corresponds to the emission reduction benefits.

8. The method of claim 1, wherein the verifying further comprises allowing an auditor to verify the emission reduction benefits.

9. The method of claim 1, further comprising providing the plurality of buyers with an opportunity to purchase at least a portion of the emission reduction benefits.

10. The method of claim 1, further comprising:
receiving an indication from at least one of the plurality of buyers to purchase at least a portion of the emission reduction benefits; and
providing the at least one of the plurality of buyers with an emission retirement guarantee for the at least a portion of the emission reduction benefits.

11. The method of claim 1, further comprising providing the plurality of buyers with a listing display that displays a plurality of emission reducing projects.

12. The method of claim 1, further comprising providing each of the plurality of buyers with an opportunity to search for the emission reducing project.

13. A method for the electronic trading of emission reduction benefits using a carbon management application, the method comprising:
assessing a supplier in connection with carbon dioxide equivalent emissions of the supplier;
creating an emission reducing project based at least in part on the assessment;
converting the emission reducing project to a volume of emission reduction benefit;
storing the volume of emission reduction benefit in a warehouse;
receiving a request from a buyer to purchase at least a portion of the volume of emission reduction benefit; and
in response to receiving the request, providing the buyer with an emission retirement guarantee, wherein the emission retirement guarantee prevents the emission reduction benefit in the warehouse from being repurchased.

14. The method of claim 13, wherein the providing further comprises:
dividing the emission reduction benefit into a plurality of smaller benefits; and
providing the plurality of smaller benefits to the buyer.

15. The method of claim 13, wherein the emission reduction benefit is a basket of emission reduction benefits.

16. The method of claim 13, further comprising allowing a broker and the supplier to determine an approach for creating the emission reducing project.

17. The method of claim 13, further comprising allowing a marketing agent and the warehouse to determine an approach for providing the volume of emission reduction benefit to the buyer.

18. The method of claim 13, wherein the storing further comprises providing the warehouse with a certificate that corresponds to the volume of emission reduction benefit.

19. The method of claim 13, wherein the verifying further comprises allowing an auditor to verify the volume of emission reduction benefit in the warehouse.

20. The method of claim 13, further comprising providing the buyer with a listing display that displays a plurality of emission reducing projects.

21. The method of claim 13, further comprising providing the buyer with an opportunity to search for the emission reducing project.

22. A method for providing emissions neutral products and services using a carbon management application, the method comprising:
receiving a request from a buyer to purchase a volume of emission reduction benefits from a warehouse;
in response to receiving the request, providing the buyer with an emission retirement guarantee, wherein the emission retirement guarantee prevents the emission reduction benefit in the warehouse from being repurchased;
associating the provided emission retirement guarantee with at least one of a product and a service, wherein the associating makes the at least one of a product and a service emissions neutral when the buyer has purchased a given amount of emission retirement guarantees;
certifying that the buyer has purchased the given amount of emission retirement guarantees; and
providing a customer with the at least one of a product and a service that is emissions neutral.

23. A method for providing emission neutral processes using an carbon management application, the method comprising:
receiving a request from a buyer to purchase a volume of emission reduction benefits from a warehouse;
in response to receiving the request, providing the buyer with an emission retirement guarantee, wherein the emission retirement guarantee prevents the emission reduction benefit in the warehouse from being repurchased; and
associating the provided emission retirement guarantee with a process, wherein the associating makes the process emissions neutral when the buyer has purchased a given amount of emission retirement guarantees;
certifying that the buyer has purchased the given amount of emission retirement guarantees; and
allowing the buyer to convert a process to an emissions neutral process based at least in part on the certification.

24. A method for assessing emissions neutrality using a carbon management application, the method comprising:
assessing a buyer, wherein the assessment comprises evaluating at least one of a product, a service, and a process of the buyer;
determining a volume of emission retirement guarantees that a buyer has to purchase to become emission neutral (“TOTAL EMISSION RETIREMENT GUARANTEES”) based at least in part on the assessment;
receiving a request from the buyer to purchase an emission retirement guarantee, wherein the purchased emission retirement guarantee is added to a total purchased volume of emission retirement guarantees (“PURCHASED EMISSION RETIREMENT GUARANTEES”); and
providing the buyer with a notification indicating emissions neutrality when PURCHASED EMISSION RETIREMENT GUARANTEES≧TOTAL EMISSION RETIREMENT GUARANTEES.

25. An apparatus for providing emission reduction benefits, the apparatus comprising:
a server storage device;
a server processor connect to the server storage device, the server storage device storing a program for controlling the server processor;
a plurality of workstations, each of the plurality of workstations operative to communicate with the server, each of the workstations comprising:
a workstation storage device;
a workstation processor connected to the workstation storage device, the workstation storage device storing a workstation program for controlling the workstation processor, the workstation processor operative with the workstation program to:
generate emission reduction benefits from an emission reducing project;
store the emission reduction benefits in a warehouse;
verify the stored emission reduction benefits; and
provide the emission reduction benefits to a plurality of buyers.

26. The apparatus of claim 25 wherein the workstation processor is further configured to:
divide the emission reduction benefits into a plurality of smaller benefits; and
provide the plurality of smaller benefits to a plurality of buyers.

27. The apparatus of claim 25 wherein the workstation processor is further configured to:
assess a supplier in connection with carbon dioxide equivalent emissions of the supplier; creating the emission reducing project based at least in part on the assessment; and
convert the emission reducing project to a volume of emission reduction benefits.

28. The apparatus of claim 25, wherein the emission reduction benefits are a basket of emission reduction benefits.

29. The apparatus of claim 25, wherein the workstation processor is further configured to allow a broker and the supplier to determine an approach for creating the emission reducing project.

30. The apparatus of claim 25, wherein the workstation processor is further configured to allow a marketing agent and the warehouse to determine an approach for providing the emission reduction benefits to the plurality of buyers.

31. The apparatus of claim 25, wherein the workstation processor is further configured to provide the warehouse with a certificate that corresponds to the emission reduction benefits.

32. The apparatus of claim 25, wherein the workstation processor is further configured to allow an auditor to verify the emission reduction benefits.

33. The apparatus of claim 25, wherein the workstation processor is further configured to provide the plurality of buyers with an opportunity to purchase at least a portion of the emission reduction benefits.

34. The apparatus of claim 25, wherein the workstation processor is further configured to:
receive an indication from at least one of the plurality of buyers to purchase at least a portion of the emission reduction benefits; and
provide the at least one of the plurality of buyers with an emission retirement guarantee for the at least a portion of the emission reduction benefits.

35. The apparatus of claim 25, wherein the workstation processor is further configured to provide the plurality of buyers with a listing display that displays a plurality of emission reducing projects.

36. The apparatus of claim 25, wherein the workstation processor is further configured to provide each of the plurality of buyers with an opportunity to search for the emission reducing project.

37. An apparatus for providing emission reduction benefits, the apparatus comprising:
a server storage device;
a server processor connect to the server storage device, the server storage device storing a program for controlling the server processor;
a plurality of workstations, each of the plurality of workstations operative to communicate with the server, each of the workstations comprising:
a workstation storage device;
a workstation processor connected to the workstation storage device, the workstation storage device storing a workstation program for controlling the workstation processor, the workstation processor operative with the workstation program to:
assess a supplier in connection with carbon dioxide equivalent emissions of the supplier;
create an emission reducing project based,at least in part on the assessment;
convert the emission reducing project to a volume of emission reduction benefit;
store the volume of emission reduction benefit in a warehouse;
receive a request from a buyer to purchase at least a portion of the volume of emission reduction benefit; and
provide the buyer with an emission retirement guarantee in response to receiving the request, wherein the emission retirement guarantee prevents the emission reduction benefit in the warehouse from being repurchased.

38. The apparatus of claim 37, wherein the workstation processor is further configured to:
divide the emission reduction benefit into a plurality of smaller benefits; and
provide the plurality of smaller benefits to the buyer.

39. The apparatus of claim 37, wherein the emission reduction benefit is a basket of emission reduction benefits.

40. The apparatus of claim 37, wherein the workstation processor is further configured to allow a broker and the supplier to determine an approach for creating the emission reducing project.

41. The apparatus of claim 37, wherein the workstation processor is further configured to allow a marketing agent and the warehouse to determine an approach for providing the volume of emission reduction benefit to the buyer.

42. The apparatus of claim 37, wherein the workstation processor is further configured to provide the warehouse with a certificate that corresponds to the volume of emission reduction benefit.

43. The apparatus of claim 37, wherein the workstation processor is further configured to allow an auditor to verify the volume of emission reduction benefit in the warehouse.

44. The apparatus of claim 37, wherein the workstation processor is further configured to provide the buyer with a listing display that displays a plurality of emission reducing projects.

45. The apparatus of claim 37, wherein the workstation processor is further configured to provide the buyer with an opportunity to search for the emission reducing project.

46. An apparatus for providing emissions neutral products and services using a carbon management application, the apparatus comprising:
a server storage device;
a server processor connect to the server storage device, the server storage device storing a program for controlling the server processor;
a plurality of workstations, each of the plurality of workstations operative to communicate with the server, each of the workstations comprising:
a workstation storage device;
a workstation processor connected to the workstation storage device, the workstation storage device storing a workstation program for controlling the workstation processor, the workstation processor operative with the workstation program to:
receive a request from a buyer to purchase a volume of emission reduction benefits from a warehouse;
provide the buyer with an emission retirement guarantee in response to receiving the request, wherein the emission retirement guarantee prevents the emission reduction benefit in the warehouse from being repurchased;
associate the provided emission retirement guarantee with at least one of a product and a service, wherein the associating makes the at least one of a product and a service emissions neutral when the buyer has purchased a given amount of emission retirement guarantees;
certify that the buyer has purchased the given amount of emission retirement guarantees; and
provide a customer with the at least one of a product and a service that is emissions neutral.

47. An apparatus for providing emission neutral processes using an carbon management application, the apparatus comprising:
a server storage device;
a server processor connect to the server storage device, the server storage device storing a program for controlling the server processor;
a plurality of workstations, each of the plurality of workstations operative to communicate with the server, each of the workstations comprising:
a workstation storage device;
a workstation processor connected to the workstation storage device, the workstation storage device storing a workstation program for controlling the workstation processor, the workstation processor operative with the workstation program to:
receive a request from a buyer to purchase a volume of emission reduction benefits from a warehouse;
provide the buyer with an emission retirement guarantee in response to receiving the request, wherein the emission retirement guarantee prevents the emission reduction benefit in the warehouse from being repurchased; and
associate the provided emission retirement guarantee with a process, wherein the associating makes the process emissions neutral when the buyer has purchased a given amount of emission retirement guarantees;
certify that the buyer has purchased the given amount of emission retirement guarantees; and
allow the buyer to convert a process to an emissions neutral process based at least in part on the certification.

48. An apparatus for assessing emissions neutrality using a carbon management application, the apparatus comprising:
a server storage device;
a server processor connect to the server storage device, the server storage device storing a program for controlling the server processor;
a plurality of workstations, each of the plurality of workstations operative to communicate with the server, each of the workstations comprising:
a workstation storage device;
a workstation processor connected to the workstation storage device, the workstation storage device storing a workstation program for controlling the workstation processor, the workstation processor operative with the workstation program to:
assess a buyer, wherein the assessment comprises evaluating at least one of a product, a service, and a process of the buyer;
determine a volume of emission retirement guarantees that a buyer has to purchase to become emission neutral (“TOTAL EMISSION RETIREMENT GUARANTEES”) based at least in part on the assessment; receiving a request from the buyer to purchase an emission retirement guarantee, wherein the purchased emission retirement guarantee is added to a total purchased volume of emission retirement guarantees (“PURCHASED EMISSION RETIREMENT GUARANTEES”); and
provide the buyer with a notification indicating emissions neutrality when PURCHASED EMISSION RETIREMENT GUARANTEES≧TOTAL EMISSION RETIREMENT GUARANTEES.
